(19) United States
(12) Patent Application Publication
(10) Pub. No.: US 2024/0151273 A1
(43) Pub. Date: May 9, 2024

(54) JOINT MEMBER FOR PROPELLER SHAFT AND PROPELLER SHAFT

(71) Applicant: Hitachi Astemo, Ltd., Hitachinaka-shi, Ibaraki (JP)

(72) Inventors: Shoichi ICHIKAWA, Hitachinaka-shi, Ibaraki (JP); Daiki TSUTSUMI, Hitachinaka-shi, Ibaraki (JP); Toshiyuki MASUDA, Hitachinaka-shi, Ibaraki (JP); Kenichiro ISHIKURA, Hitachinaka-shi, Ibaraki (JP)

(73) Assignee: Hitachi Astemo, Ltd., Hitachinaka-shi, Ibaraki (JP)

(21) Appl. No.: 18/549,241

(22) PCT Filed: Dec. 16, 2021
(86) PCT No.: PCT/JP2021/046410

§ 371 Date: Sep. 6, 2023

(30) Foreign Application Priority Data
Mar. 12, 2021 (JP) 2021-040278

(51) Int. Cl. F16D 3/06; B60K 17/22; F16D 3/38

(52) U.S. Cl. CPC F16D 3/06; F16D 3/387; B60K 17/22; F16D 2300/08

(57) ABSTRACT

As a stopper for restricting movement of a rotary shaft 31 of a transmission device 3 and a shaft part 41 of a first drive-side joint member J11 in a direction of approaching each other, a stopper part 5 is formed separately from the shaft part 41 and a yoke body part 42 of the first drive-side joint member so that the stopper function of the first drive-side joint member J11 is guaranteed by the separately-formed stopper part 5 in the present invention. With this configuration, a change in the gravity center position of the first drive-side joint member caused due to build-up processing on the shaft part or the yoke body part is suppressed. It is possible to restrict relative movement of the first drive-side joint member and the rotary shaft while ensuring adequate machining for formation of a shaft-part-side seal surface on the first drive-side joint member.

### FIELD OF THE INVENTION

The present invention relates to a joint member for a propeller shaft and a propeller shaft.

### BACKGROUND ART

As a conventional propeller shaft, there is known a propeller shaft of the type disclosed in Patent Document 1.

As outlined herein, this propeller shaft is connected at one axial end side thereof to a transmission via a first joint member and connected at the other axial end side thereof to a differential gear via a second joint member. The first joint member includes a cylindrical shaft part on a distal end side thereof with a female spline portion formed on an inner circumferential surface of the shaft part, whereas the transmission includes a columnar rotary shaft with a male spline portion formed on an outer circumferential surface of the rotary shaft. By engagement of these spline portions, the propeller shaft and the transmission are integrally rotatably coupled to each other.

The first joint member also includes a yoke body part formed in a stepped diameter-increased shape on a proximal end of the shaft part such that a pair of yokes are provided on the yoke body part. In the above-mentioned spline connection, relative axial movement of the propeller shaft and the transmission rotary shaft is restricted by bringing a distal end of the transmission rotary shaft into contact with the bottom of the stepped diameter-increased yoke body part.

### PRIOR ART DOCUMENTS

### Patent Document

Patent Document 1: Japanese Laid-Open Patent Publication No. 2003-184853

### SUMMARY OF THE INVENTION

### Problem to be Solved by the Invention

Herein, an annular seal member is fitted between an outer circumferential surface of the shaft part of the first joint member and a case (housing) of the transmission. The outer circumferential surface of the shaft part of the first joint member thus defines a seal surface with which the annular seal member is brought into close contact. It is accordingly necessary to form the seal surface by machining the outer circumferential surface of the shaft part of the first joint member. The machining of the outer circumferential surface of the shaft part for formation of the seal surface is carried out in a state of rotating the first joint member by the application of a rotational driving force from a spline shaft in engagement with the female spline portion of the shaft part.

In the case of the conventional propeller shaft joint member (first joint member), the stopper for restricting relative axial movement of the first joint member and the transmission rotary shaft is adjusted in position by performing build-up processing on the bottom of the yoke body part. Depending on the degree of build-up processing, the gravity center position of the first joint member may be biased toward the yoke side. There is a possibility that the first joint member, when rotated during the machining, would toward the yoke side along the spline due to the bias of the gravity center position. This becomes a hindrance to the machining of the outer circumferential surface (seal surface) of the shaft part.

The present invention has been made in view of the above-mentioned technical problem of the conventional propeller shaft joint member and propeller shaft. It is an object of the present invention to provide a joint member for a propeller shaft, capable of properly restricting relative movement of the joint member and its counterpart rotary shaft while suppressing a change in the gravity center position of the joint member, and to provide a propeller shaft with such a joint member.

### Means for Solving the Problems

One aspect of the present invention is a joint member for a propeller shaft, wherein a stopper part is formed separately from a shaft part and a yoke body part so as to restrict relative approaching movement of a vehicle rotary shaft and the shaft part.

### Effects of the Invention

The present invention provides the effect of properly restricting relative movement of the joint member and the counterpart rotary shaft while suppressing a change in the gravity center position of the joint member.

### BRIEF DESCRIPTION OF DRAWINGS

FIG. 1 is a half longitudinal sectional view of a propeller shaft in which the present invention is embodied.

FIG. 2 is a longitudinal sectional view of a first drive-side joint member according to a first embodiment of the present invention, as provided in the propeller shaft of FIG. 1.

FIG. 3 is an enlarged sectional view of a connection between the first drive-side joint member of FIG. 2 and an output rotary shaft of a transmission.

FIG. 4 is a longitudinal sectional view of a first drive-side joint member according to a second embodiment of the present invention.

FIG. 5 is an enlarged sectional view of a connection between the first drive-side joint member of FIG. 4 and an output rotary shaft of a transmission.

FIG. 6 is a longitudinal sectional view of a first drive-side joint member according to a third embodiment of the present invention.

FIG. 7 is an enlarged sectional view of a connection between the first drive-side joint member of FIG. 6 and an output rotary shaft of a transmission.

### DESCRIPTION OF EMBODIMENTS

Hereinafter, joint members for propeller shafts and propeller shafts according to exemplary embodiments of the present invention will be described in detail below with reference to the drawings. It is herein noted that each of the following exemplary embodiments refers to the case where the joint member for the propeller shaft and the propeller shaft with the joint member are applied to a propeller shaft of a vehicle as in the conventional case.

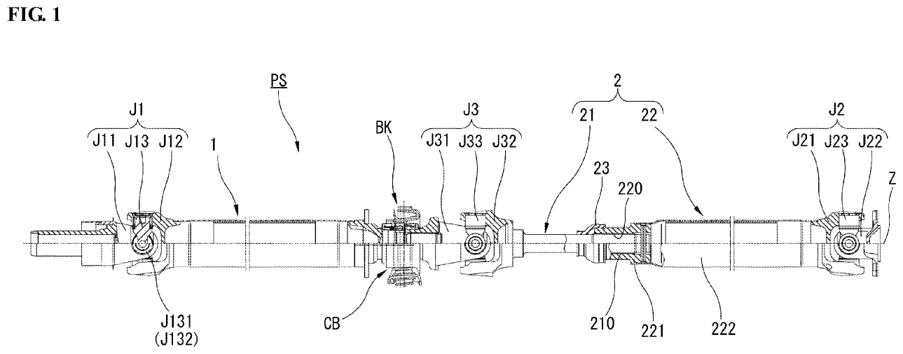

In the following description, the terms “front” and “rear” are used to indicate the left and right sides of each drawing, respectively, for the sake of convenience. Further, the term “axial” is used to indicate a direction along a rotation axis Z of a propeller shaft PS in FIG. 1; and the term “circumferential” is used to indicate a direction along a circumference of the rotation axis Z.

### First Embodiment

(Configuration of Propeller Shaft)

FIG. 1 is a half sectional view showing the overall configuration of a propeller shaft PS according to the first embodiment of the present invention.

As shown in FIG. 1, the propeller shaft PS is arranged in a front-rear direction of a vehicle at a location between a first rotary shaft disposed in a front side of the vehicle and a second rotary shaft disposed in a rear side of the vehicle. In the case where the vehicle is a FR (front-engine, rear-wheel) drive vehicle, for example, the first rotary shaft corresponds to an output rotary shaft of a transmission device (also simply referred to as a transmission) disposed in the front side of the vehicle such that a torque is transmitted from a drive source such as an engine or a motor to the first rotary shaft; and the second rotary shaft corresponds to an input rotary shaft of a differential gear (also simply referred to as a differential) disposed in the rear side of the vehicle such that a torque is transmitted from the second rotary shaft to rear wheels of the vehicle.

In the first embodiment, the propeller shaft PS has a two-piece structure constituted by two separate front and rear side pieces. More specifically, the propeller shaft PS includes a first shaft member 1 coupled to the transmission device (transmission) via a first joint J1 and a second shaft member 2 coupled to the differential gear (differential) via a second joint J2. These first and second shaft members are coupled to each other via a third joint J3 so as to be integrally rotatable about a rotation axis Z.

A front end portion of the first shaft member 1 is integrally rotatably connected to the rotary shaft of the transmission device (transmission) via the first joint J1. A rear end portion of the first shaft member 1 is rotatably supported by a bracket BR via a center bearing CB, which is suspended on the vehicle body, and is integrally rotatably connected to the second shaft member 2 via the third joint J3.

A front end portion of the second shaft member 2 is integrally rotatably connected to the first shaft member 1 via the third joint J3. A rear end portion of the second shaft member 2 is integrally rotatably connected to the rotary shaft of the differential gear (differential) via the second joint J2. In the first embodiment, the second shaft member 2 is constituted by two separate axial parts, that is, a columnar first shaft part 21 located on a front side thereof and a cylindrical second shaft part 22 located on a rear side thereof. The first and second shaft parts 21 and 22 are connected by spline connection of the after-mentioned male and female spline portions 210 and 220 so as to be relatively movable in an axial direction. A cover 23 made of a rubber is disposed between and astride the first and second shaft parts 21 and 22 so as to cover the connection between the first and second shaft parts 21 and 22 and thereby prevent the entry of any foreign substance in between the spline-connected portions.

The first shaft part 21 is fixed at a front end region thereof by press-fitting to a rear end side of the after-mentioned third driven-side joint member J32 of the third joint J3. A spline portion 210 is formed on an outer circumferential surface of a rear end region of the first shaft part 21. The second shaft part 22 is divided into two axial portions including a second-shaft-part connection portion 221 provided on a front side thereof for connection to the first shaft part 21 and a second-shaft-part body portion 222 provided on a rear side thereof as a body of the second shaft part 22.

The second-shaft-part connection portion 221 is made of a given metal material in a cylindrical shape with a relatively large thickness. A female spline portion 220 is formed on an inner circumferential surface of the second-shaft-part connection portion 221. The second-shaft-part body portion 222 is made of a fiber-reinforced plastic material, typified by FRP, in a cylindrical shape with a relatively small thickness. Further, the second-shaft-part body portion 222 is fixed at a front end side thereof by press-fitting in a rear end side of the second-shaft-part connection portion 221 and is fixed at a rear end side thereof by press-fitting in a front end side of the after-mentioned second drive-side joint member J21 of the second joint J2.

The first joint J1 includes a first drive-side joint member J11 connected to the rotary shaft of the transmission device (transmission), a first driven-side joint member J12 connected to the first shaft member 1 and a first joint cross J13 coupling the first drive-side joint member J11 and the first driven-side joint member J12 to each other.

The second joint J2 includes a second drive-side joint member J21 connected to the second shaft part 22 of the second shaft member 2, a second driven-side joint member J22 connected to the rotary shaft of the differential gear (differential) and a second joint cross J23 coupling the second drive-side joint member J21 and the second driven-side joint member J22 to each other.

The third joint J3 includes a third drive-side joint member J31 connected to the first shaft member 1, a third driven-side joint part J32 connected to the first shaft part 21 of the second shaft member 2 and a third joint cross J33 coupling the third drive-side joint member J31 and the third driven-side joint member J32 to each other.

(Configuration of Joint Member)

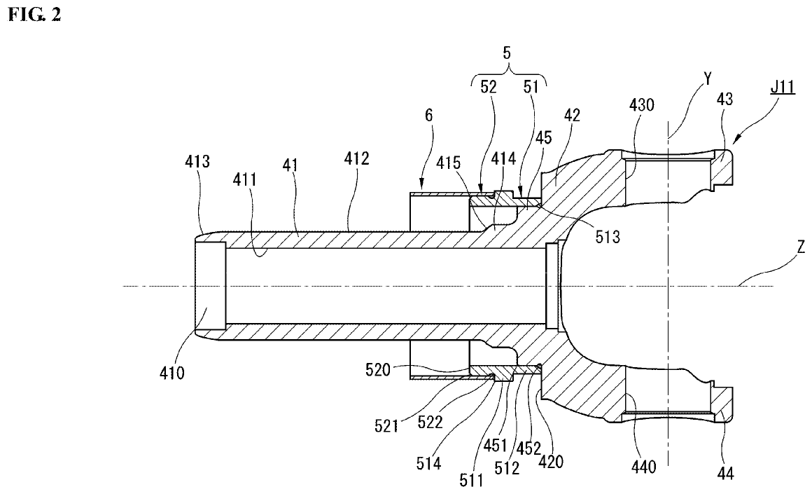

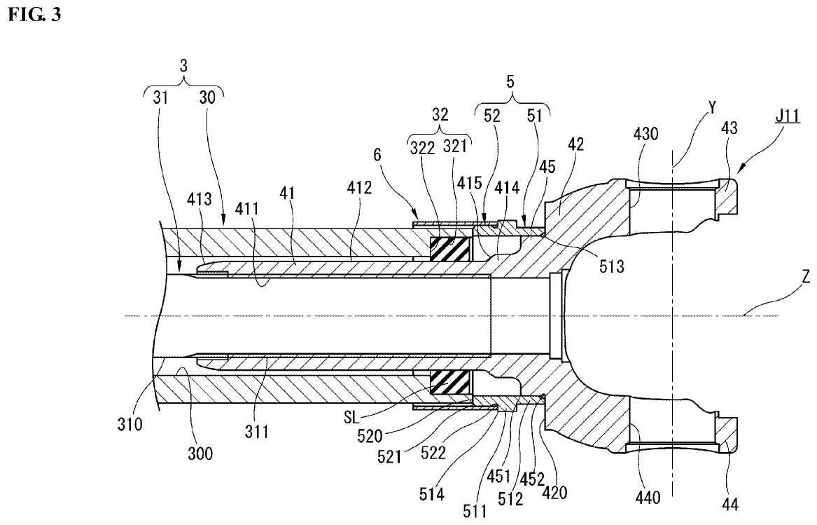

FIG. 2 is a longitudinal sectional view of the first drive-side joint member J11 according to the first embodiment of the present invention, as taken along the rotation axis Z of the propeller shaft PS. FIG. 3 is an enlarged sectional view of the connection between the first drive-side joint member J11 and the output rotary shaft of the transmission device (transmission), as taken along the rotation axis Z of the propeller shaft PS. In the first embodiment, the first drive-side joint member J11 corresponds to a joint member for a propeller shaft according to the present invention.

As shown in FIGS. 2 and 3, the first drive-side joint member J11 has: a shaft part 41 spline-connected to the rotary shaft 31 of the transmission device 3 mounted on the vehicle; a yoke body part 42 formed in a diameter-increased flange shape on a rear end of the shaft part 41; and a pair of yokes 43 and 44 branched in a bifurcated manner from the yoke body part 42 and extending opposite to the shaft part 41 in the axial direction. The shaft part 41, the yoke body part 42 and the pair of yokes 43 and 44 are formed integrally in one piece by forging.

The shaft part 41 is cylindrical in shape, with a shaft-part through hole 410 formed on an inner circumferential side thereof and extending therethrough in the axial direction, such that the rotary shaft 31 of the transmission device 3 is received in the shaft-part through hole 410. A shaft-part-side spline portion 411 is formed on a predetermined region of the shaft-part though hole 410 in the axial direction so as to be engageable with the after-mentioned rotary-shaft-side spine portion 311 which is formed on an outer circumferential side of the rotary shaft 31 of the transmission device 3.

A shaft-part-side seal surface 412 is defined on an outer circumferential surface of the shaft part 41 such that a substantially annular seal member SL, when fitted (in a radial space) between the shaft part 41 and a case 30 of the transmission device 3, is brought into close contact with the shaft-part-side seal surface 412. As in the conventional case, this shaft-part-side seal surface 412 is formed by performing machining (finishing) on the shaft part while rotating the entire first drive-side joint member J11 by rotation of a rotary shaft of machining equipment in engagement with the shaft-part-side spline portion 411.

A shaft-part outer-circumferential-side tapered section 413 is formed, on an outer circumferential edge of a distal end region of the shaft part 41, in a substantially conical tapered shape with its outer diameter gradually decreased toward the distal end. This prevents, at the time when the shaft part 41 is inserted into the case 30 with the seal member SL arranged in the case 30 as will be explained later, an inner circumferential surface of the seal member SL from being damaged by the distal end of the shaft part 41 during sliding of the shaft part 41 over the inner circumferential surface of the seal member SL.

On an outer circumferential side of a proximal end region of the shaft part 41, a middle diameter portion 414 is formed with its diameter increased in a stepped manner relative to the shaft-part-side seal surface 412. The outer diameter of the middle diameter portion 414 is set larger than that of the shaft-part-side seal surface 412 and smaller than that of the after-mentioned step part 45. The middle diameter portion 414 and the shaft-part-side seal surface 412 are connected by a middle-diameter-side tapered section 415, which is formed in a substantially conical tapered shape with its outer diameter gradually increased toward the middle diameter portion 414, rather than by a vertical plane perpendicular to the rotation axis Z.

The yoke body part 42 is substantially circular plate-shaped with its diameter increased in a stepped manner relative to the shaft part 41. A stopper-part contact surface 420 for abutting contact with the after-mentioned stopper part 5 is defined on the bottom (front end surface) of the yoke body part 42 in parallel with a radial line Y perpendicular to the rotation axis Z.

The pair of yokes 43 and 44 are provided to extend in the axial direction from an outer circumferential edge of the yoke body part 42. The yokes 43 and 44 are made larger in thickness than the shaft part 41. A pair of shaft through holes 430 and 440, into which a pair of shaft parts J131 and J132 (see FIG. 1) of the first joint cross J13 are engageable, are respectively formed through the pair of yokes 43 and 44 in a thickness direction of the yokes 43 and 44 such that these shaft through holes are radially opposed to and face each other via the rotation axis Z.

A sleeve-shaped stopper part 5 is provided on the outer circumferential side of the shaft part 41 so as to function as a stopper for restricting movement of the shaft part 41 and the rotary shaft 31 of the transmission device 3 in a direction of approaching each other. This stopper part 5 is formed separately from the shaft part 41 and the yoke body part 42. In the first embodiment, a step part 45 is formed in a stepped diameter-increased shape at a location between the shaft part 41 and the yoke body part 42; and the stopper part 5 is made of a metal material such as carbon steel in a cylindrical shape and is fixed by press-fitting to an outer circumferential side of the step part 45 with a rear end of the stopper part 5 being in abutting contact with the stopper-part contact surface 420.

A step-part-side tapered section 451 is formed, on an outer circumferential edge of a front end region of the step part 45, in a substantially conical tapered shape with its outer diameter gradually decreased toward the front. A step-part-side annular groove 452 is formed in a rear end region of the step part 45, which is connected to the yoke body part 42, such that the outer diameter of the step-part-side annular groove 452 is decreased relative to that of a general section of the step part 45. This step-part-side annular groove 452 is substantially arc-shaped when viewed in cross section (longitudinal cross section) along the axial direction.

The stopper part 5 has: a stopper body portion 51 press-fitted to the outer circumferential side of the step part 45; and a stopper contact portion 52 extending from the stopper body portion 51 in the axial direction so as to be opposed to and contactable with the case 30 of the transmission device 3. In the first embodiment, the stopper body portion 51 and the stopper contact portion 52 are formed integrally as one piece. Herein, the stopper body portion 51 and the stopper contact portion 52 have the same constant inner diameter to define an axially continuous flat surface on an inner circumferential side of the stopper part 5 in parallel with the rotation axis Z.

The stopper body portion 51 includes: a large thickness section 511 provided on a front end side thereof and connected to the stopper contact portion 52; and a small thickness section 512 provided on a rear end side thereof with a smaller thickness than that of the large thickness section 511 and press-fitted onto the step part 45. A stopper-part inner-circumferential-side tapered section 513 is formed on an inner circumferential edge of a rear end region of the small thickness section 512 in a substantially conical tapered shape with its thickness dimension gradually decreased toward the rear.

The stopper contact portion 52 extends from a front end of the stopper body portion 51 (large thickness section 511) in the axial direction, and has a stopper contact surface 520 defined on a distal end thereof for contact with a rear end of the case 30 of the transmission device 3. The stopper contact surface 520 is defined as a flat surface extending in parallel with the radial line Y perpendicular to the rotation axis Z so as to, when the stopper contact portion is brought into abutting contact with the case 30, make surface contact with the rear end surface of the case 30. As shown in FIG. 3, the amount of extension of the stopper contact portion 52 is set so as to restrict relative movement of the rotary shaft 31 and the first drive-side joint member J11 in a state that the shaft-part-side spline portion 411 is positioned within the formation region of the after-mentioned rotary-shaft-side spline portion 311, i.e., positioned before running onto the after-mentioned general portion 310 of the rotary shaft 31.

The stopper contact portion 52 is formed to extend in a stepped diameter-decreased shape on a front end side of the large thickness section 511 of the stopper body portion 51. The outer diameter of the stopper contact portion 52 is set smaller than that of the large thickness section 511 and larger than that of the small thickness section 512. In other words, the stopper contact portion 52 is decreased in diameter in a stepped manner relative to the large thickness section 511. A cover-part contact surface 514 for abutting contact with the after-mentioned cover part 6 is thus defined on the front end of the large thickness section 511, which is connected to the stopper contact portion 52, in parallel with the radial line Y perpendicular to the rotation axis Z.

Furthermore, the outer diameter of the stopper contact portion 52 is set slightly larger than that of the end of the case 30 of the transmission device 3 opposed to the stopper contact portion 52 (that is, the rear end of the case 30). By setting the outer diameter of the stopper contact portion 52 slightly larger than that of the end of the case 30 opposed to the stopper contact portion 52 (the rear end of the case 30), there is a slight radial gap left between (radially between) an inner circumferential surface of the after-mentioned cover part 6 disposed on an outer circumferential side of the stopper contact portion 52 and an outer circumferential surface of a rear end region of the case 30.

A stopper-part outer-circumferential-side tapered section 521 is formed on an outer circumferential side of a distal end region of the stopper contact portion 52 in a substantially conical tapered shape with its outer diameter gradually decreased toward the distal end. Further, a stopper-contact-portion-side annular groove 522 is formed in a proximal end region of the stopper contact portion 52 connected to the stopper body portion 51 (large thickness section 511) such that the outer diameter of the stopper-contact-portion-side annular groove 522 is decreased relative to that of a general section of the stopper contact portion 52. This stopper-contact-portion-side annular groove 522 is substantially arc-shaped when viewed in cross section (longitudinal cross section) along the axial direction.

A cover part 6 is disposed on the outer circumferential side of the stopper contact portion 52 at a position overlapping the case 30 of the transmission device 3 in the axial direction so as to cover a radial gap occurring between the case 30 and the stopper contact portion 52 in a state of the case 30 and the stopper contact portion 52 being separated from each other and thereby prevent adhesion of any foreign substance to the shaft-part-side seal surface 412. (The radial gap is not shown in FIG. 3 because the case 30 and the stopper contact portion 52 are in contact with each other in this figure.) In the first embodiment, the cover part 6 is made of a metal material such as SPCC in a cylindrical shape of constant inner and outer diameters with a relatively small thickness, and is fixed by press-fitting to the outer circumferential side of the stopper contact portion 52 with a rear end of the cover part 6 being in contact with the cover-part contact surface 514.

(Configuration of Transmission Device)

In the transmission device 3, the case 30 is made of a metal material in a substantially cylindrical shape, with an axial through hole 300 formed through the case 30 in the axial direction, as shown in FIG. 3. The rotary shaft 31, which is coupled to a speed change gear, is installed in the case 30. The inner diameter of the axial through hole 300 of the case 30 is set slightly larger than the outer diameter of the shaft part 41 of the first drive-side joint member J11 so that the shaft part 41, which overlaps the outer circumferential side of a rear end portion of the rotary shaft 31 by the after-mentioned spline connection, is inserted and placed in a rear end side of the axial through hole 300 of the case 30.

A seal holding portion 32 is provided on an inner circumferential side of the rear end region of the case 30 such that the substantially annular seal member SL is held in the seal holding portion 32 to establish a fluid-tight sealing between the inner circumferential surface of the case 30 and the outer circumferential surface (shaft-part-side seal surface 412) of the shaft part 41. This seal holding portion 32 is formed by increasing the diameter of the axial through hole 300 in a stepped manner in the rear end region of the case 30. Herein, the seal holding portion 32 is defined by: a first case-side seal surface 321 extending in parallel with the rotation axis Z for close contact with an outer circumferential surface of the seal member SL; and a second case-side seal surface 322 extending perpendicular to the rotation axis Z for close contact with an axial end surface (front end surface) of the seal member SL.

The seal member SL is axially entirely placed in the seal holding portion 32 and held in abutting contact with the end wall (second case-side seal surface 322) of the seal holding portion 32. By close contact of the outer circumferential surface of the seal member SL with the first case-side seal surface 321, close contact of the axial end surface of the seal member SL with the second case-side seal surface 322 and close contact of the inner circumferential surface of the seal member SL with the shaft-part-side seal surface 412, a transmission fluid (as a lubricant) stored in the case 30 is prevented from flowing out.

The rotary shaft 31 has: a columnar general portion 310; and a rotary-shaft-side spline portion 311 formed on a predetermined rear end region of the general portion 310 (i.e. a predetermined axial region of the general portion inserted in the shaft-part through hole 410), with a smaller diameter than that of the general portion 310, so as to be spline-engageable with the shaft-part-side spline portion 411 of the first drive-side joint member J11. With such a configuration, the rotary-shaft-side spline portion 311 and the shaft-part-side spline portion 411 are engaged in the formation region of the rotary-shaft-side spline portion 311 whereby the rotary shaft 31 and the first drive-side joint member J11 are axially movable relative to each other.

(Effects of First Embodiment)

In the case of the conventional propeller shaft joint member (first drive-side joint member), the stopper for restricting relative movement of the transmission rotary shaft and the first drive-side joint member is adjusted in position by performing build-up processing on the bottom of the yoke body part or the rear end side (proximal end side) of the shaft part. Depending on the degree of build-up processing, however, the gravity center position of the first drive-side joint member may be biased toward the yoke side. There is a possibility that, during the process of machining the outer circumferential surface (shaft-part-side seal surface) of the shaft part while rotating the shaft part by rotation of the spline shaft of the machining equipment in spline connection with the spline portion of the shaft part, the shaft part would shift toward the yoke side along the spline due to the bias of the gravity center position. This becomes a hindrance to the machining of the outer circumferential surface (shaft-part-side seal surface) of the shaft part.

The propeller shaft joint member (first drive-side joint member J11) and the propeller shaft PS according to the first embodiment provide the following effects to solve the above-mentioned technical problem of the conventional propeller shaft joint member and propeller shaft.

The joint member (first drive-side joint member J11) according to the first embodiment is that used for the propeller shaft coupled to the rotary shaft 31 of the vehicle, and includes: the shaft part 41 movable relative to the rotary shaft 31 in the axial direction along the rotation axis Z of the rotary shaft 31 such that the shaft part 41 and the rotary shaft 31 approach each other, the shaft part 41 having the shaft-part-side spline portion 411 spline-connected to the rotary-shaft-side spline portion 311 which is formed on the distal end side of the general portion 310 of the rotary shaft 31 with a smaller diameter than that of the general portion 310; the yoke body part 42 connected to a side of the shaft part 41 opposite to the portion of the shaft part 41 spline-connected to the rotary shaft 31 in the axial direction; the pair of yokes 43 and 44 branched in a bifurcated manner from the yoke body part 42 and extending opposite to the portion of the shaft part 41 spline-connected to the rotary shaft 31 in the axial direction; and the stopper (stopper part 5) formed separately from the shaft part 41 and the yoke body part 42 and adapted to restrict relative approaching movement of the rotary shaft 31 and the shaft part 41.

As mentioned above, the stopper part 5 as the stopper is formed separately from the shaft part 41 and the yoke body part 42 so that the stopper function of the first drive-side joint member J11 is guaranteed by such a separately-formed stopper part 5 in the first embodiment. This suppresses a change in the gravity center position of the first drive-side joint member J11 caused during build-up processing on the shaft part 41 or the yoke body part 42. Therefore, the first embodiment enables to restrict relative movement of the first drive-side joint member J11 and the rotary shaft 33 while ensuring adequate machining of the shaft-part-side seal surface 412.

In the first embodiment, the step part 45 is formed, with a larger diameter than that of the shaft part 41, between the shaft part 41 and the yoke body part 42 on the outer circumferential side of the proximal end region of the shaft part 41; and the stopper (stopper part 5) is press-fitted onto the step part 45.

By press-fitting the stopper part 5 onto the step part 45, the stopper part 5 is fixed firmly so as to exert a good stopper function.

Further, the stopper (stopper part 5) has the stopper body portion 51 press-fitted to the outer circumferential side of the step part 45 and the stopper contact portion 52 extending from the stopper body portion 51 so as to be opposed to and contactable with the case 30 in which the rotary shaft 31 is installed; and the cover (cover part 6) is press-fitted to the outer circumferential side of the stopper contact portion 52 at a position overlapping the case 30 in the axial direction.

By arranging the cover part 6 on the outer circumferential side of the stopper part 5 so as to cover the case 3, any foreign substance is prevented from entering between the spline-connected portions of the rotary shaft 31 and the shaft part 41. This ensures good sliding of the rotary shaft 31 and the first drive-side joint member J11 in the spline connection between the rotary shaft 31 and the shaft part 41.

Since the stopper part 5 and the cover part 6 are formed separately from each other, the stopper part 5 and the cover part 6 can be made of materials respectively suitable for their functions. This leads to improvements in functionality of the stopper part 5 and the cover part 6 as well as reductions in production cost.

In the first embodiment, the stopper (stopper part) 5 has the stopper body portion 51 press-fitted to the outer circumferential side of the step part 45 and the stopper contact portion 52 extending from the stopper body portion 51 so as to be opposed to and contactable with the case 30 of the transmission device 3, wherein one axial end region (small thickness section 512) of the stopper body portion 51 press-fitted onto the step part 45 is made smaller in thickness than the other axial end region (large thickness section 511) of the stopper body portion 51 connected to the stopper contact portion 52.

As the axial end region of the stopper body portion 51 press-fitted onto the step part 45 is formed with a relatively small thickness as the small thickness section 512, it becomes easy to press-fit the stopper part 5 onto the step part 45 by such a small thickness section. This leads to improvement in press-fitting workability of the stopper part 5 to the step part 45.

Furthermore, the proximal end region of the step part 45 connected to the yoke body part 42 is made smaller in outer diameter than the distal end region of the step part 45 connected to the shaft part 41 in the first embodiment.

More specifically, the step-part-side annular groove 452 is formed in the proximal end region of the step part 45 such that the proximal end region of the step part 45 is decreased in outer diameter relative to the general portion of the step part in the first embodiment. It is thus possible to suppress formation of a rounded portion on the boundary between the step part 45 and the yoke body part 42. This ensures large allowance for press-fitting the stopper part 5 to the step part 45 and allows adequate contact of the rear end of the stopper part 5 with the stopper-part contact surface 420, thereby enabling to firmly fix the stopper part 5 to the step part 45.

In addition, the stopper-part inner-circumferential-side tapered section 513 is provided on the inner circumferential edge of the rear end region of the stopper part 5 in such a manner that the thickness dimension of the tapered portion 513 is gradually decreased toward the rear in the first embodiment. By providing the stopper-part inner-circumferential-side tapered section 513, it becomes easier to avoid a rounded portion which could be formed on the boundary between the step part 45 and the yoke body part 42 during forging of the first drive-side joint member J11. This allows reliable abutting contact of the rear end of the stopper part 5 with the stopper-part contact surface 420, thereby enabling to firmly fix the stopper part 5 to the step part 45.

In the first embodiment, the stopper body portion 51 is press-fitted onto the step part 45 in a state of being in abutting contact with the end surface (stopper-part contact surface 420) of the yoke body part 42.

As the stopper body portion 51 is arranged in abutting contact with the end surface (stopper-part contact surface 420) of the yoke body part 42 as mentioned above, the force exerted on the stopper part 5 from the rotary shaft 31 during restriction of relative movement of the rotary shaft 31 can be received by the end surface (stopper-part contact surface 420) of the yoke body part 42. This leads to improvement in rigidity of the stopper part 5.

### Second Embodiment

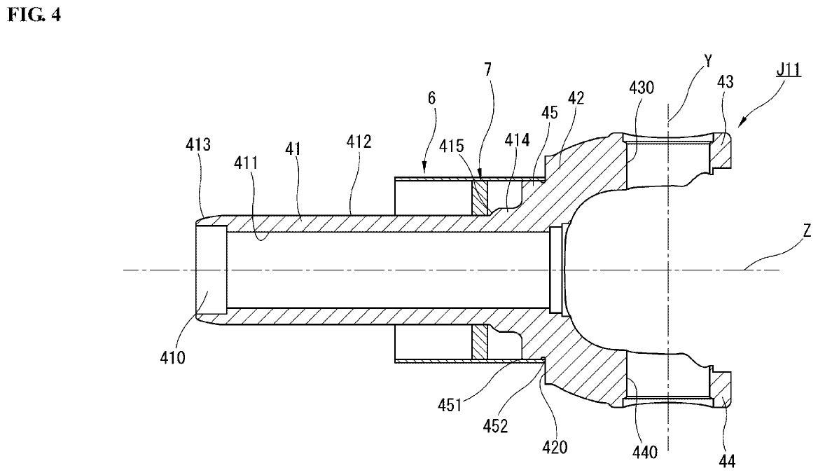

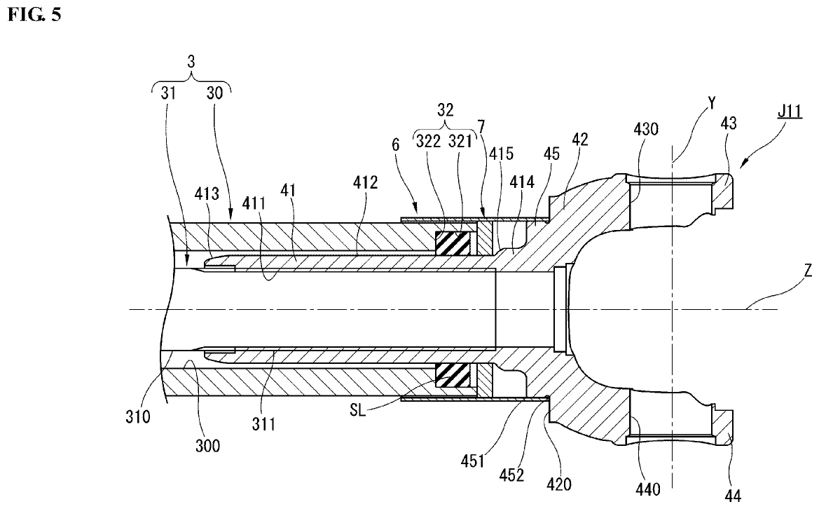

FIGS. 4 and 5 show a joint member for a propeller shaft and a propeller shaft according to the second embodiment of the present invention. The second embodiment is implemented by modifying the stopper part configuration of the first drive-side joint member J11 of the first embodiment. Since the basic configuration of the second embodiment except the modified stopper part configuration is the same as that of the first embodiment, the same parts and portions of the second embodiment as those of the first embodiments are designated by the same reference numerals to omit related explanations thereof.

FIG. 4 is a longitudinal sectional view of the first drive-side joint member J11 according to the second embodiment of the present invention, as taken along the rotation axis Z of the propeller shaft PS. FIG. 5 is an enlarged sectional view of the connection between the first drive-side joint member J11 of FIG. 4 and the output rotary shaft of the transmission device (transmission), as taken along the rotation axis Z of the propeller shaft PS.

In the first drive-side joint member J11 of the second embodiment, as shown in FIGS. 4 and 5, a stopper part 7 is provided as a stopper for restricting movement of the shaft part 41 and the rotary shaft 31 of the transmission device 3 in a direction of approaching each other. Herein, the stopper part 7 is made of a metal material in the form of a spacer and is formed separately from the shaft part 41 and the yoke body part 42. This stopper part 7 is in a cylindrical shape of constant outer diameter, with both axial end surfaces thereof flattened, and is disposed slidably on the shaft-part-side seal surface 412.

More specifically, the stopper part 7 is disposed so as to be movable (slidable) in the axial direction on the outer circumferential side of the shaft-part-side seal surface 412. When the transmission device 3 and the propeller shaft PS approach closest to each other, the stopper part 7 is held between the case 30 of the transmission device 3 and the middle diameter portion 414 with a front end surface of the stopper part 7 being in contact with a rear end surface of the case 30 and a rear end edge of the stopper part 7 being in contact with a front end edge of the middle-diameter-side tapered section 415. In this state, the stopper part 7 performs the function of restricting relative movement of the first drive-side joint member J11 and the rotary shaft 31 of the transmission device 3.

In the second embodiment, the outer diameter of the step part 45 of the first drive-side joint member J11 is set slightly larger than that of the case 30 of the transmission device 3; and the cover part 6 is press-fitted to the outer circumferential side of the step part 45 of the first drive-side joint member J11. At this time, the stopper part 7 is disposed slidably relative to the cover part 6 in the second embodiment. The stopper part 7 may be disposed apart from the cover part 6, rather than disposed slidably on the cover part 6.

As mentioned above, in the second embodiment, the cylindrical spacer (stopper part 7) is provided as the stopper on the outer circumferential side of the shaft part 41 so as to be slidable relative to the shaft part 41 and contactable with the case 30 in which the rotary shaft 31 is installed.

Since the stopper part 7 is provided in spacer form and disposed slidably relative to the shaft part 41 in the second embodiment, it becomes easier to assemble the stopper part 7 into the first drive-side joint member J11 as compared to the case where the stopper part 7 is fixed by press-fitting to the first drive-side joint member J11 (step part 45) as in the first embodiment. This leads to improvement in assembling workability of the stopper part 7.

In the second embodiment, the step part 45 is formed, with a larger diameter than that of the shaft part 41, between the shaft part 41 and the yoke body part 42 on the proximal end region of the shaft part 41; and the cover (cover part 6) is press-fitted to the outer circumferential side of the step part 45 so as to, in the axial direction, overlap the case 30 in which the rotary shaft 31 is installed.

By arranging the cover part 6 on the outer circumferential side of the step part 45 so as to cover the case 30, any foreign substance is prevented from entering between the spline-connected portions of the rotary shaft 31 and the shaft part 41. This ensures good sliding of the rotary shaft 31 and the shaft part 41 in the spline connection between the rotary shaft 31 and the shaft part 41.

Since the stopper part 7 and the cover part 6 are formed separately from each other, the stopper part 7 and the cover part 6 can be made of materials respectively suitable for their functions. This leads to improvements in functionality of the stopper part 7 and the cover part 6 as well as reductions in production cost.

### Third Embodiment

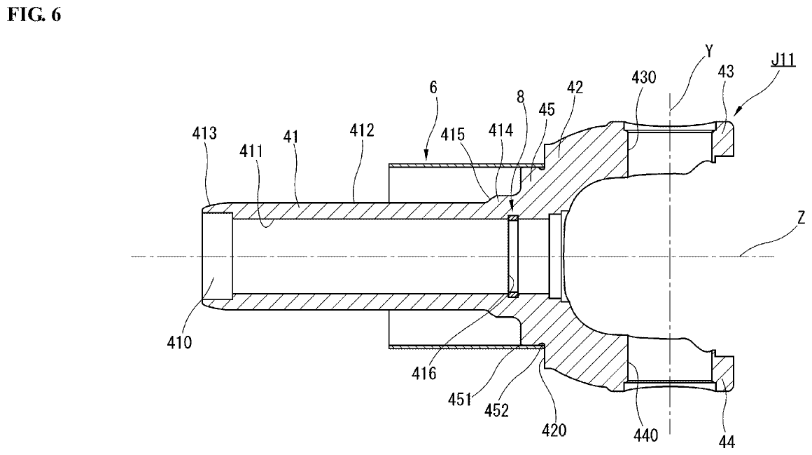

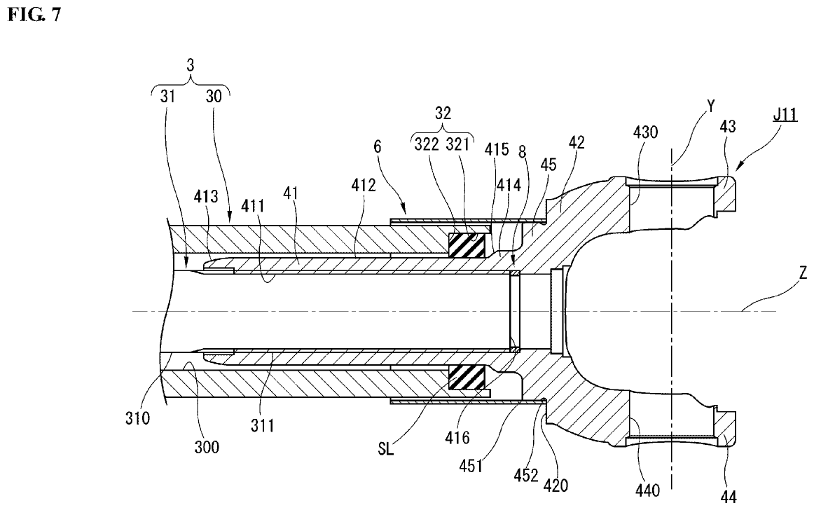

FIGS. 6 and 7 show a joint member for a propeller shaft and a propeller shaft according to the third embodiment of the present invention. The third embodiment is implemented by modifying the stopper part configuration of the first drive-side joint member J11 of the second embodiment. Since the basic configuration of the third embodiment except the modified stopper part configuration is the same as that of the first embodiment, the same parts and portions of the third embodiment as those of the first embodiments are designated by the same reference numerals to omit related explanations thereof.

FIG. 6 is a longitudinal sectional view of the first drive-side joint member J11 according to the third embodiment of the present invention, as taken along the rotation axis Z of the propeller shaft PS. FIG. 7 is an enlarged sectional view of the connection between the first drive-side joint member J11 of FIG. 6 and the output rotary shaft of the transmission device (transmission), as taken along the rotation axis Z of the propeller shaft PS.

In the first drive-side joint member J11 of the third embodiment, as shown in FIGS. 6 and 7, a circumferentially continuous annular ring groove 416 is formed in a rear end region of the shaft-part-side spline portion 411 within the shaft-part through hole 410; and a stopper part 8 in the form of a C-ring is fitted in the ring groove 416 as a stopper for restricting relative movement of the rotary shaft 31 of the transmission device 3 and the shaft part 41 in a direction of approaching each other.

More specifically, the stopper part 8 is formed so as to, in a state of being fitted in the ring groove 416, be smaller in inner diameter than the rear end portion of the rotary shaft 3 of the transmission device 3. When the transmission device 3 and the propeller shaft PS approach closest to each other, the stopper part 8 performs the function of restricting relative movement of the rotary shaft 31 of the transmission device 3 and the first drive-side joint member J11 by contact of a front end surface of the stopper part 8 with a rear end surface of the rotary shaft 31 of the transmission device 3.

Even during such a relative movement restriction state where the rotary shaft 31 of the transmission device 3 is in contact with the stopper part 8, the seal member SL is held to a rear end region of the shaft-part-side seal surface 412 so that adequate sealing performance of the seal member SL is ensured.

As mentioned above, in the third embodiment, the shaft part 41 is formed in a cylindrical shape such that the rotary shaft 31 is insertable in and spline-connectable to the shaft part 41; and the C-ring (stopper part 8) is provided as the stopper in the annular ring groove 416, which is formed in the inner circumferential side of the shaft part 41, so as to be contactable with the distal end of the rotary shaft 31.

Since the C-ring (stopper part 8) is used as the stopper by being fitted in the inner circumferential side (shaft-part-side spline portion 41) of the shaft part 41, it becomes possible to achieve a weight reduction of the first drive-side joint member J11 as compared to the case where the stopper is arranged on the outer circumferential side of the shaft part 41.

In the third embodiment, the C-ring (stopper part 8) is arranged at a position biased toward the yoke body part 42 in the axial direction.

By arranging the C-ring (stopper part 8) at a position biased toward the yoke body part 42 in the axial direction, the amount of engagement between the rotary shaft 31 and the shaft part 41 (i.e. the length of engagement between the rotary shaft 31 and the shaft part 41 in the axial direction) can be set relatively large. This allows relatively large torque transmission from the rotary shaft 31 to the shaft part 41.

The present invention is not limited to the configurations and features of the above-described embodiments. As long as the above-described effects can be achieved, various changes and modifications of the embodiments can be freely made depending on the specifications and cost of the application target of the present invention.

For example, the following aspects are possible on the basis of the joint members for the propeller shafts according to the above-described embodiments.

According to one aspect, provided is a joint member for a propeller shaft coupled to a rotary shaft of a vehicle, comprising:
a shaft part movable relative to the rotary shaft in an axial direction along a rotation axis of the rotary shaft in such a manner that the shaft part and the rotary shaft approach each other, the rotary shaft having a rotary-shaft-side spline portion formed on a distal end side of a general portion thereof with a smaller diameter than that of the general portion, the shaft part having a shaft-part-side spline portion spline-connected to the rotary-shaft-side spline portion;
a yoke body part connected to a side of the shaft part opposite to the portion of the shaft part spline-connected to the rotary shaft in the axial direction;
a pair of yokes branched in a bifurcated manner from the yoke body part and extending opposite to the portion of the shaft part spline-connected to the rotary shaft in the axial direction; and
a stopper part formed separately from the shaft part and the yoke body part and adapted to restrict relative approaching movement of the rotary shaft and the shaft part.

According to a preferred aspect, the joint member for the propeller shaft is provided as above, wherein the joint member comprises a step part formed, with a larger diameter than that of the shaft part, between the shaft part and the yoke body part on an outer circumferential side of a proximal end region of the shaft part, and wherein the stopper part is press-fitted onto the step part.

According to another preferred aspect, the joint member for the propeller shaft is provided as above, wherein the stopper part has: a stopper body portion press-fitted to an outer circumferential side of the step part; and a stopper contact portion extending from the stopper body portion so as to be opposed to and contactable with a case in which the rotary shaft is installed, and wherein the joint member comprises a cover part press-fitted to an outer circumferential side of the stopper contact portion so as to overlap the case in the axial direction.

According to still another preferred aspect, the joint member for the propeller shaft is provided as above, wherein the stopper part has: a stopper body portion press-fitted to an outer circumferential side of the step part; and a stopper contact portion extending from the stopper body portion so as to be opposed to and contactable with a case in which the rotary shaft is stalled, and wherein, in the axial direction, one end region of the stopper body portion connected to the stopper contact portion is made smaller in thickness than the other end region of the stopper body portion press-fitted onto the step part.

According to still another preferred aspect, the joint member for the propeller shaft is provided as above, wherein a proximal end region of the step part connected to the yoke body part is made smaller in outer diameter than a distal end region of the step part connected to the shaft part.

According to still another preferred aspect, the joint member for the propeller shaft is provided as above, wherein the stopper body portion is press-fitted onto the step part in a state of being in abutting contact with an end surface of the yoke body portion.

According to still another preferred aspect, the joint member for the propeller shaft is provided as above, wherein the stopper part is in the form of a cylindrical spacer and is disposed on an outer circumferential side of the shaft part, slidably relative to the shaft part, so as to be contactable with a case in which the rotary shaft is installed.

According to still another preferred aspect, the joint member for the propeller shaft is provided as above, wherein the shaft part is in a cylindrical shape such that the rotary shaft is insertable in and spline-connectable to the rotary shaft, and has an annular ring groove formed in an inner circumferential side thereof, and wherein the stopper part is in the form of a C-ring and is fitted in the annular ring groove so as to be contactable with a distal end of the rotary shaft.

According to still another preferred aspect, the joint member for the propeller shaft is provided as above, wherein the joint member comprises: a step part formed, with a larger diameter than that of the shaft part, between the shaft part and the yoke body part on a proximal end region of the shaft part; and a cover part press-fitted to an outer circumferential side of the step part so as to overlap, in the axial direction, a case in which the rotary shaft is installed.

According to still another preferred aspect, the joint member for the propeller shaft is provided as above, wherein the C-ring is arranged at a position biased toward the yoke body part in the axial direction.

Further, the following aspect is possible on the basis of the propeller shafts according to the above-described embodiments.

According to one aspect of the present invention, provided is a propeller shaft coupled to a rotary shaft of a vehicle, comprising: a propeller shaft body; and a joint member connecting the propeller shaft body to the rotary shaft, the joint member comprising:
a shaft part movable relative to the rotary shaft in an axial direction along a rotation axis of the rotary shaft in such a manner that the shaft part and the rotary shaft approach each other, the rotary shaft having a rotary-shaft-side spline portion formed on a distal end side of a general portion thereof with a smaller diameter than that of the general portion, the shaft part having a shaft-part-side spline portion spline-connected to the rotary-shaft-side spline portion;
a yoke body part connected to a side of the shaft part opposite to the portion of the shaft part spline-connected to the rotary shaft in the axial direction;
a pair of yokes branched in a bifurcated manner from the yoke body part and extending opposite to the portion of the shaft part spline-connected to the rotary shaft in the axial direction; and
a stopper part formed separately from the shaft part and the yoke body part and adapted to restrict relative approaching movement of the rotary shaft and the shaft part.

1. A joint member for a propeller shaft, the propeller shaft being coupled to a rotary shaft of a vehicle, the joint member comprising:
a shaft part movable relative to the rotary shaft in an axial direction along a rotation axis of the rotary shaft in such a manner that the shaft part and the rotary shaft approach each other, the rotary shaft having a rotary-shaft-side spline portion formed on a distal end side of a general portion thereof with a smaller diameter than that of the general portion, the shaft part having a shaft-part-side spline portion spline-connected to the rotary-shaft-side spline portion;
a yoke body part connected to a side of the shaft part opposite to the portion of the shaft part spline-connected to the rotary shaft in the axial direction;
a pair of yokes branched in a bifurcated manner from the yoke body part and extending opposite to the portion of the shaft part spline-connected to the rotary shaft in the axial direction; and
a stopper part formed separately from the shaft part and the yoke body part and adapted to restrict relative approaching movement of the rotary shaft and the shaft part.

2. The joint member for the propeller shaft according to claim 1,
wherein the joint member comprises a step part formed, with a larger diameter than that of the shaft part, between the shaft part and the yoke body part on an outer circumferential side of a proximal end region of the shaft part, and
wherein the stopper part is press-fitted onto the step part.

3. The joint member for the propeller shaft according to claim 2,
wherein the stopper part has: a stopper body portion press-fitted to an outer circumferential side of the step part; and a stopper contact portion extending from the stopper body portion so as to be opposed to and contactable with a case in which the rotary shaft is installed, and
wherein the joint member comprises a cover part press-fitted to an outer circumferential side of the stopper contact portion so as to overlap the case in the axial direction.

4. The joint member for the propeller shaft according to claim 2,
wherein the stopper part has: a stopper body portion press-fitted to an outer circumferential side of the step part; and a stopper contact portion extending from the stopper body portion so as to be opposed to and contactable with a case in which the rotary shaft is installed, and
wherein, in the axial direction, one end region of the stopper body portion connected to the stopper contact portion is made smaller in thickness than the other end region of the stopper body portion press-fitted onto the step part.

5. The joint member for the propeller shaft according to claim 2,
wherein a proximal end region of the step part connected to the yoke body part is made smaller in outer diameter than a distal end region of the step part connected to the shaft part.

6. The joint member for the propeller shaft according to claim 5,
wherein the stopper body portion is press-fitted onto the step part in a state of being in abutting contact with an end surface of the yoke body portion.

7. The joint member for the propeller shaft according to claim 1,
wherein the stopper part is in the form of a cylindrical spacer and is disposed on an outer circumferential side of the shaft part, slidably relative to the shaft part, so as to be contactable with a case in which the rotary shaft is installed.

8. The joint member for the propeller shaft according to claim 1,
wherein the shaft part is in a cylindrical shape such that the rotary shaft is insertable in and spline-connectable to the rotary shaft, and has an annular ring groove formed in an inner circumferential side thereof, and
wherein the stopper part is in the form of a C-ring and is fitted in the annular ring groove so as to be contactable with a distal end of the rotary shaft.

9. The joint member for the propeller shaft according to claim 7,
wherein the joint member comprises: a step part formed, with a larger diameter than that of the shaft part, between the shaft part and the yoke body part on a proximal end region of the shaft part; and a cover part press-fitted to an outer circumferential side of the step part so as to overlap, in the axial direction, a case in which the rotary shaft is installed.

10. The joint member for the propeller shaft according to claim 8,
wherein the C-ring is arranged at a position biased toward the yoke body part in the axial direction.

11. A propeller shaft coupled to a rotary shaft of a vehicle, comprising:
a propeller shaft body; and a joint member connecting the propeller shaft body to the rotary shaft,
the joint member comprising:
a shaft part movable relative to the rotary shaft in an axial direction along a rotation axis of the rotary shaft in such a manner that the shaft part and the rotary shaft approach each other, the rotary shaft having a rotary-shaft-side spline portion formed on a distal end side of a general portion thereof with a smaller diameter than that of the general portion, the shaft part having a shaft-part-side spline portion spline-connected to the rotary-shaft-side spline portion;
a yoke body part connected to a side of the shaft part opposite to the portion of the shaft part spline-connected to the rotary shaft in the axial direction;
a pair of yokes branched in a bifurcated manner from the yoke body part and extending opposite to the portion of the shaft part spline-connected to the rotary shaft in the axial direction; and
a stopper part formed separately from the shaft part and the yoke body part and adapted to restrict relative approaching movement of the rotary shaft and the shaft part.

12. The joint member for the propeller shaft according to claim 8,
wherein the joint member comprises: a step part formed, with a larger diameter than that of the shaft part, between the shaft part and the yoke body part on a proximal end region of the shaft part; and a cover part press-fitted to an outer circumferential side of the step part so as to overlap, in the axial direction, a case in which the rotary shaft is installed.
